(19) United States
(12) Patent Application Publication
(10) Pub. No.: US 2020/0283318 A1
(43) Pub. Date: Sep. 10, 2020

(54) LIQUID PURIFICATION PROCESSES, SYSTEMS THEREFOR, AND COMPONENTS THEREOF

(71) Applicant: Rickey S. Lutterbach, Long Beach, IN (US)

(72) Inventor: Rickey S. Lutterbach, Long Beach, IN (US)

(21) Appl. No.: 16/351,222

(22) Filed: Mar. 12, 2019

Related U.S. Application Data
(60) Provisional application No. 62/641,706, filed on Mar. 12, 2018.

(51) Int. Cl. C02F 9/00; C02F 1/00; C02F 1/02; C02F 1/48

(52) U.S. Cl. CPC C02F 9/00; C02F 1/004; C02F 2101/22; C02F 1/488; C02F 2201/008; C02F 1/025

(57) ABSTRACT

Processes and systems suitable for purifying or otherwise treating liquids to remove contaminants therein, including but not limited to purifying contaminated water to render the water suitable for human consumption, bathing, etc. Such a process and system entail the use of a purification system that heats a liquid from the feedstock to yield a more purified form of the liquid. The purification system can be operated to selectively process the feedstock through any of a series of vessels at which different amounts and/or contaminants may be removed from the feedstock.

### CROSS REFERENCE TO RELATED APPLICATIONS

This application claims the benefit of U.S. Provisional Application No. 62/641,706, filed Mar. 12, 2018. In addition, this application is related to co-pending U.S. patent application Ser. No. 15/603,822 filed May 24, 2017, and Ser. No. 15/686,695 filed Aug. 25, 2017. The contents of these prior applications are incorporated herein by reference.

### BACKGROUND OF THE INVENTION

The present invention generally relates to systems and processes for performing liquid treatments, as examples, liquid purification to permit an intended use for a liquid, including but not limited to human consumption, bathing, etc. The invention particularly relates to systems and processes capable of purifying water from feedstocks that may be contaminated, including but not limited to groundwater, flood water, surface water, wastewater, industrial water, seawater, brackish water, and agriculture water.

There are many technologies that exist to treat contaminated water for reintroduction into rivers, lakes, irrigation, mechanical equipment, or a municipal water system for human consumption. For example, it is advantageous to recover water from various sources, for example wastewater, industrial water, groundwater, flood water, surface water, seawater, brackish water, and agriculture water, especially in regions of the world where fresh water is not regularly available or is unavailable due to a catastrophic event, such as a hurricane, tsunami, earthquake, floods, forest fires, etc. Such locations include desert regions, near sea coasts, or remote locations that do not have significant or sufficient surface water or access to surface water, locations where groundwater must be transported by truck, and locations where investment in deep well construction may not be possible or practical due to physical site limitations such as mountains, slopes, or unstable soil conditions. Various treatment technologies have benefits and shortcomings, depending on the raw water quality, location, energy cost, capital cost, end use of the recovered water, and the ease of operation.

Existing and conventional liquid treatment methods require a large amount of energy, high pressure, and/or large equipment footprints and site infrastructure. Consequently, such methods are expensive to build, operate, and maintain. Moreover, the equipment required to perform existing and conventional treatment methods do not provide versatility regarding the degree to which a particular liquid can be purified.

The issues described above are particularly problematic when water is not widely available or unavailable for human consumption, bathing, etc., due to a catastrophic event, such as a hurricane, tsunami, earthquake, floods, forest fires, etc. Under these circumstances, governments often resort to shipping bottled water to those impacted. While addressing the immediate need for potable water, bottled water is not an optimal solution for addressing bathing needs, and vast amounts of empty plastic bottles create environmental issues. As such, there exists a need for processes and systems that are capable of purifying or otherwise treating liquids, including but not limited to water from feedstocks that may be contaminated, to permit an intended use, including but not limited to water for human consumption, bathing, etc. It would be particularly desirable if such processes and systems offered versatility as to the locations and environments in which such systems can be used.

### BRIEF DESCRIPTION OF THE INVENTION

The present invention provides processes and systems suitable for purifying or otherwise treating liquids to remove contaminants therein, including but not limited to contaminated water.

According to one aspect of the invention, a process is provided for purifying a feedstock that may contain any of a wide variety of contaminants, and involves heating the feedstock in a series of vessels to yield a more purified form of a liquid component of the feedstock. The purification system can be operated to selectively process the feedstock through any of the vessels at which different amounts and/or contaminants may be removed from the feedstock.

According to another aspect of the invention, a purification system is provided that is capable of purifying a liquid feedstock as described above.

Optional aspects of the invention include operating the system at pressure levels above atmospheric pressure to control and, if so desired, suppress flash evaporation (distillation).

Technical aspects of the processes and apparatus described above preferably include the ability to produce a liquid that is sufficiently purified for its intended end use, while requiring relatively lower amounts of energy to do so. In addition, such processes and systems offer the ability to provide purification at various selective levels as desired by the end user's requirements, rather than being limited to a fully purified liquid end product. Moreover, preferred systems of this invention are highly mobile, can be transported and placed where needs are most severe, do not require large amounts of capital for construction, and promote high ratios of gallons of treated feedstock to equipment footprint.

Other aspects and advantages of this invention will be appreciated from the following detailed description.

### BRIEF DESCRIPTION OF THE DRAWINGS

FIG. 1 schematically represents a perspective view of a purification system in accordance with a nonlimiting first embodiment of the present invention.

FIG. 2 schematically represents a fluid circuit for the purification system represented in FIG. 1.

FIGS. 3 and 4 schematically represent external and cross-sectional views, respectively, of a purification vessel suitable for use in the system of FIGS. 1 and 2.

FIG. 5 schematically represents a cross-sectional view of an alternative purification vessel suitable for use in the system of FIGS. 1 and 2.

FIG. 6 schematically represents a perspective view of an enclosure suitable for housing the purification system of FIGS. 1 and 2 in accordance with a nonlimiting embodiment of the present invention.

FIGS. 7 and 8 schematically represent two configurations of a mobile unit that houses two purification systems of FIGS. 1 and 2 in accordance with a nonlimiting embodiment of the present invention.

FIG. 9 schematically represents a fluid circuit for a purification system in accordance with a nonlimiting second embodiment of the present invention.

### DETAILED DESCRIPTION OF THE INVENTION

The present invention encompasses purification systems, processes, and equipment for removing one or more contaminants from a feedstock through a series of purification steps, with the result that the feedstock is purified or otherwise treated to yield a liquid component of the feedstock that is suitable for an intended use, a particular but nonlimiting example of which is water purification for human consumption, bathing, etc. The various forms of the word “purify” will be used herein to describe processes performed by the systems shown in the drawings to indicate that the processes entail heating a feedstock to obtain a purer form of the liquid by removing and/or neutralizing matter that would be detrimental to the intended use of the liquid, for example, the removal and/or neutralization of solids, bacteria, viruses, microbes, and parasites from a water feedstock that would be harmful to humans consuming or bathing with the water.

The availability of clean safe water for humans who have been subjected to a catastrophic event, such as a hurricane, tsunami, earthquake, floods, forest fires, etc., is a particular problem sought to be addressed by the present invention, and therefore the remainder of this detailed description will often refer to the purification of water for consumption and use, though it should be understood that the teachings of this invention are applicable to other liquids and feedstocks.

Water feedstocks may be obtained from a variety of sources, including but not limited to groundwater, flood water, surface water, wastewater, fracking water, seawater, brackish water, storm water, fertigation, and agriculture water.

Contaminants removed from the feedstock may be one or more of chromium (including hexavalent chromium (chromium(VI)), arsenic, lead, calcium, boron, magnesium, and/or essentially any other elements of the periodic table, salt and other naturally-occurring and synthetic inorganic compounds, oils, fatty acids and other naturally-occurring and synthetic organic compounds, volatile compounds including refrigerants, solvents, lubricating fluids, hydraulic fluids, and fuels, radioactive particles, bacteria, viruses, microbes, parasites, or a wide variety of other compounds or matter that may be considered a contaminant with respect to the desired end use for the treated liquid produced by the purification system and process.

The purification system comprises multiple purification vessels (tanks) fluidically connected in series to yield what will be referred to as a cascading purification system. Within a first of the vessels, the feedstock undergoes heating (preferably with a controlled amount of evaporation) to yield a first purified portion of the feedstock liquid. Within one or more subsequent vessels in the series, one or more purified portions of the feedstock liquid obtained from one or more upstream vessels undergoes additional heating, ultimately yielding a treated liquid having a desired level of purity, in other words, a contaminant content below a prescribed level for the intended end use of the liquid. For example, depending on its intended use, water purified from a feedstock may be potable or nonpotable. As such, the treated liquid ultimately produced by the purification system may be partially or completely free of contaminants. Alternatively, a feedstock may be processed so that the resulting treated liquid intentionally contains one or more contaminants, for example, salt for conductivity in mechanical equipment.

The operation of the cascading purification system can preferably be performed at temperatures that are at or above the boiling temperature of the liquid at atmospheric conditions by increasing the pressure within at least some of the vessels to something greater than atmospheric pressure, as a nonlimiting example, a pressure of up to about 1.2 atmospheres. Heating of purified portions of the feedstock liquid can be promoted by configuring and equipping the vessels in accordance with nonlimiting but preferred aspects of the invention. Ultimately, a preferred but nonlimiting aspect of the invention is the ability to provide an improved and efficient process for producing water from a wide variety of feedstocks, and that the recovered water is safe for human consumption, bathing, etc., regardless of the source of the feedstock.

Other preferred but nonlimiting aspects of the invention include the ability to configure the purification system to be highly mobile, as nonlimiting examples, a mobile system that can be towed, transported by plane, helicopter, ship, train, etc., or transported using a skid-mounted system. As such, an entire mobile system comprising one or more purification systems, or an individual purification system, or individual components (for example, vessels) of a purification system can be moved from location to location for short term or long term use. Individual purification systems and mobile systems comprising one or more purification systems may also achieve relatively low capital costs and/or maintenance costs and have a relatively small footprint.

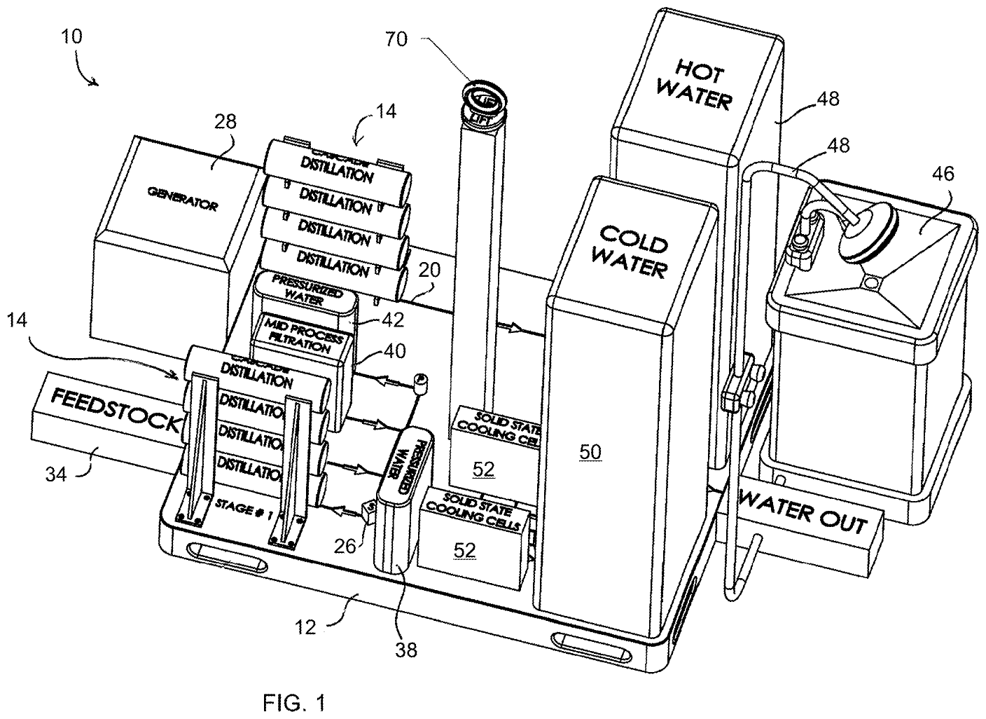

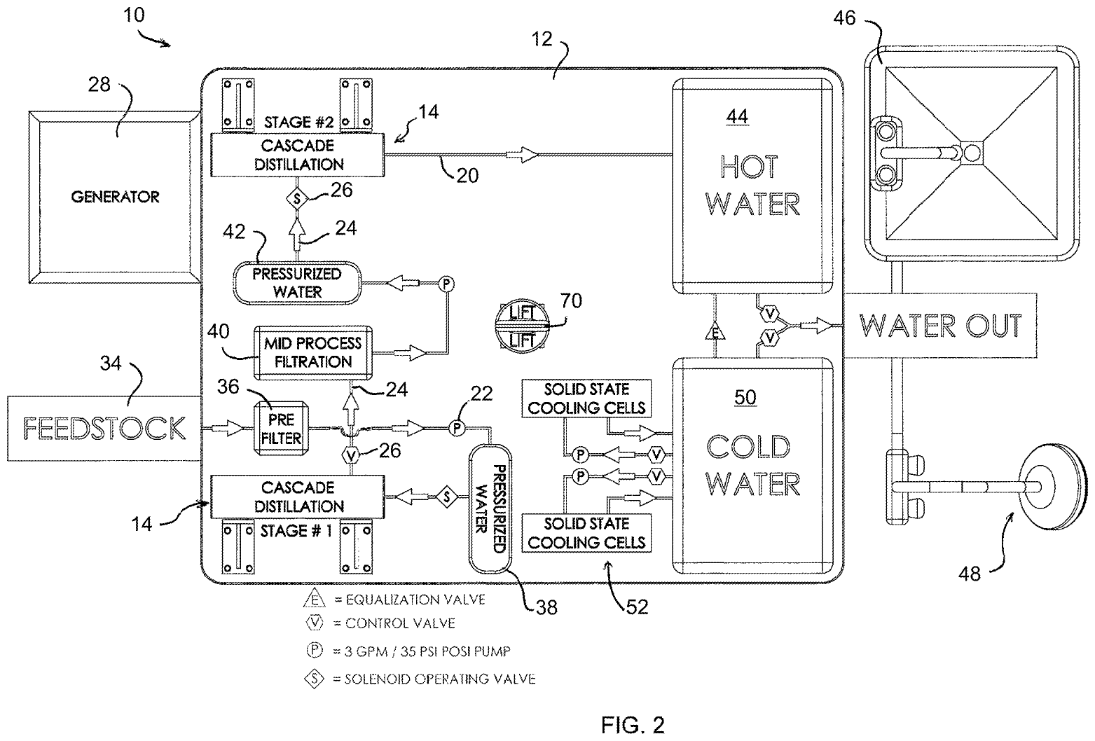

With reference to FIGS. 1 and 2, a nonlimiting embodiment of a cascading purification system 10 is represented as being constructed and supported on a platform 12, represented as being configured to facilitate the mobility of the system 10. The system 10 comprises a series of tanks or vessels 14, within which the feedstock (comprising a liquid) is heated to temperatures that are at or above the boiling temperature of the liquid at atmospheric conditions. Each vessel 14 is closed except for specific required entrance and exit points, for example, pipes or channels (not shown) that transport the feedstock and purified portions of the feedstock liquid to or from the vessels 14. The vessels 14 are connected in fluidic series with inter-vessel pipes (not shown) that connect each vessel 14 to at least one other vessel 14 in the series. Flow of a feedstock through the vessels 14 is initiated with one vessel 14 and, as will be explained below, continues through any one or more of the downstream vessels 14 toward an outlet 20 of the series to define what is referred to herein as the flow direction of the system 10. As will also be explained, flow through the vessels 14 may terminate at any of the vessels 14 prior to the series outlet 20. Each inter-vessel pipe is preferably equipped with a valve (not shown) to selectively permit and prevent flow between immediately adjacent pairs of vessels 14. In the nonlimiting embodiment shown in FIGS. 1 and 2, two sets of vessels 14 are also fluidically interconnected through pipes 24 equipped with valves 26. In combination, the inter-vessel pipes, pipes 24, and valves 26 enable flow from any vessel 14 in a set to be routed to any downstream or upstream vessel 14 in the set, and enable flow from any vessel 14 to be routed to the outlet 20.

The purification system 10 is illustrated in FIGS. 1 and 2 as further comprising additional equipment for handling the feedstock prior to its entry into the vessels 14, handling the feedstock and purified liquid after it exits the series of vessels 14, and controlling the overall operation of the system 10 and its individual vessels 14. Electrical power for the operation of the system 10 is provided with a power source 28. The particular type of power source 28 used will depend on where the system 10 is deployed, and may encompass electricity generated by or otherwise available from generators, batteries, wind turbine, solar, hydroelectric, or power available from the local electrical grid. The purification process performed by the vessels 14 can be automated and controlled by a suitable control unit, for example, a programmable logic controller (PLC) which can control the operation of the valves 26 as well as control or process the outputs of various other devices, nonlimiting examples of which include switches (for example, limit switches), sensors (for example, temperature and pressure sensors), and thermal devices (for example, heaters and coolers) located within or otherwise associated with the vessels 14. Alternatively or in addition, the system 10 or certain aspects of its operation may be manually controlled. The system may include a control panel (not shown) to display various information concerning the operation of the system 10 and certain devices of the system 10, along with visual and audible indicators and warnings so that an operator can quickly identify if a device or the system 10 as a whole is operating outside a prescribed range or is otherwise exhibiting some type of operating anomaly.

FIGS. 1 and 2 schematically represent a source 34 of the feedstock, though as previously noted feedstocks processed with the system 10 can come from a wide variety of sources. The feedstock preferably passes through one or more pre-filter units 36 to reduce the amounts of particulates that enter the vessels 14, and may then be optionally held in a pressurized tank 38 before being delivered to the vessels 14. Nonlimiting examples of pre-filter units 36 include sand filters capable of filtering particles of about 10 micrometers or less. The feedstock within the tank 38 may be treated to dissolve certain contaminants, and/or microorganisms can be added to the tank 38 to initiate or promote the purification of the feedstock. The holding tank 38 may be equipped to preheat the feedstock prior to entering the purification vessels 14. Suitable heat sources for this purpose include but are not limited to burners, inline heaters, and solar panels. The feedstock can be delivered to the tank 38 and vessels 14 by various means, including gravity feed or with a pump 22.

FIGS. 1 and 2 show the first set of vessels 14 receiving the feedstock directly from the tank 38, and the second set receiving the feedstock from the first set of vessels 14. From the first set of vessels 14, flow preferably progresses through a mid-process filtration unit 40 before continuing to a second pressurized tank 42 that contains the feedstock that was at least partially purified by the first set of vessels 14. The filtration unit 40 is preferably capable of removing finer contaminants (e.g., five micrometers or less) from the feedstock than the pre-filter unit 36, such that the total dissolved solids (TDS) level in the feedstock is drastically reduced. However, it should be noted that the pre-filter unit 36 and filtration unit 40 are not required to remove microscopic matter such as bacteria, viruses, microbes, and parasites in the liquid, as these are killed by the vessels 14 as will be described in more detail below. However, the filtration 40, tanks 38 and 42, or additional equipment may be adapted to treat certain potentially unappealing characteristics of the treated feedstock, for example, the color of the treated feedstock. From the tank 42, the treated liquid can be pumped to the second set of vessels 14, from which the final treated liquid is transferred to an onsite storage vessel 44. Because the treated liquid has been heated to temperatures that are at or above the boiling temperature of the liquid at atmospheric conditions, the liquid within the vessel 44 is labeled as “hot” in FIGS. 1 and 2. In the context of the liquid being water, FIGS. 1 and 2 show the hot water as being immediately available for use, for example, at a sink 46 or shower 48. Alternatively or in addition, the water can be cooled and stored in a storage vessel 50, labeled as “cold” in FIGS. 1 and 2. Various means can be employed for cooling the water, a nonlimiting example of which is solid state cooling cells 52 as taught in U.S. Patent Application Publication No. 2019/0063799, whose contents are incorporated herein by reference. In preferred embodiments, water stored in the cold storage vessel 50 is at a suitable temperature for drinking, and can be combined with hot water in the storage vessel 50 for washing, showering, etc.

As previously discussed, the purification system 10 is configured to enable the system 10, or at least one or more of its individual vessels 14, to operate under a pressure that is greater than the local atmospheric pressure. The intent of operation at above atmospheric pressures is to inhibit boiling and control (and in some cases suppress) flash evaporation (distillation) of the liquid from the feedstock within the vessels 14. As used herein, flash evaporation refers to a liquid instantly being vaporized upon contact with a heat source, as opposed to being gradually heated to its boiling temperature. However, the system 10 preferably allows some level of evaporation to occur for the purpose of increasing the pressure within each vessel 14. In particular, by maintaining a pressure of greater than atmospheric pressure within the vessels 14, harmful bacteria, viruses, microbes, and parasites in the liquid can be killed without the need to collect vapors of the liquid being purified from the feedstock. In the case of water, whose standard atmospheric boiling temperature is 212° F. (100° C.), the temperature of water within the vessels 14 may be at or above 212° F. (for example, about 220° F.) with some but limited evaporation by increasing the pressure within the vessels 14 above one atmosphere, as a nonlimiting example, to about 1.2 atmospheres (about 1216 mbar). Because heating is able to occur at higher temperatures within the vessels 14, preheating of the feedstock with the tanks 38 and 42 before the feedstock enters each set of vessels 14 can be particularly advantageous for quickly reaching a suitable temperature for at least partially purifying the liquid within the first vessel 14 of each set.

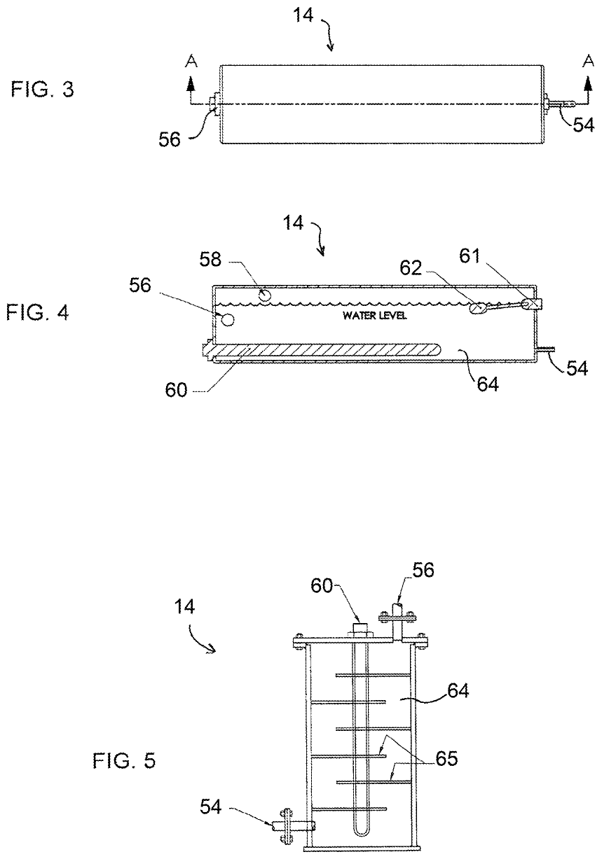

FIGS. 3 and 4 represent a nonlimiting example of one of the vessels 14. As evident from FIGS. 3 and 4, the vessels 14 are tubular shaped, with a feedstock inlet 54, feedstock outlet 56, vapor port 58, and heating element 60. The vessel 14 defines an interior chamber 64, which is preferably completely closed and airtight except for the aforementioned inlet 54, outlet 56, and port 58. The heating element 60 heats the feedstock within the vessel 14 to a temperature capable of killing bacteria, viruses, microbes, and parasites within the feedstock, as well as inducing some level of evaporation within the vessel 14 to increase the vapor pressure in the vessel 14. Pressure sensors (not shown) may be used in combination with a control unit to regulate the heating element 60 and maintain a desired pressure level within the vessel 14. The pressure sensors also serve to ensure that excessive vapor buildup does not lead to excessive pressures within the vessels 14. Vapors may be prevented from escaping the vessels 14 through the vapor port 58 unless valves (not shown) are opened to allow the vapors to escape, where the vapors may be condensed, aggregated, and then forwarded to the outlet 20 or recycled back to any one or more of the vessels 14. The vapor port 58 may also be used to exhaust trace amounts of vapors and gases that are generated in the vessels 14 and cannot be released into the atmosphere. A float switch 61 and float 62 are utilized to provide feedback to ensure that the heating element 60 is operated while the vessel 14 contains an appropriate amount of feedstock. The outlet 56 of each vessel 14 connects the vessel 14 to the inlet 54 of an immediately adjacent vessel 14. Pipes (not shown) connected to the inlet 54 and outlet 56 of each vessel 14 enable the flow from any vessel 14 to be routed to any downstream or upstream vessel 14, and enable flow from any vessel 14 to be routed to the outlet 20 of the series.

Examples of suitable heating elements 60 include one or more conventional water heating elements that are rated at sufficient wattage to heat the volume of feedstock to the desired temperature. Additionally, multiple heating elements can be implemented for heating the liquid, and secondary heaters may be used to maintain the feedstock or liquid at a constant temperature once the feedstock is initially heated to a sufficient temperature to initiate killing harmful bacteria, viruses, microbes, and parasites in the liquid. One or more temperature sensors (not shown) can be used to monitor the temperature of the feedstock or liquid within the interior chamber 64 of the vessel 14. Notably, by completely submersing the heating element 60 in the liquid and maintaining pressures within the vessel 14 above atmospheric pressure, flash evaporation (distillation) that would promote evaporation can be controlled and, if desired, can be largely if not completely suppressed.

The vessels 14 are represented in FIGS. 1 through 4 as adapted to operate while horizontal. FIG. 5 represents an embodiment of a vessel 14 intended to operate while in a vertical orientation. Advantages of the vertical orientation include the ability to fill the vessel 14 from the bottom and have the treated feedstock exit the vessel 14 at a higher elevation to mitigate residual air pockets that might develop during the startup or operation of the system 10. The vessel 14 is configured to be completely filled with the feedstock, and is equipped with baffles 65 to increase the residence time of the feedstock within the vessel 14 and promote the heating rate achieved with the heating element 60.

Various different materials can be used in the construction of the vessels 14 that are capable of withstanding the temperatures, pressures, and chemical environments within and surrounding the vessels 14. Nonlimiting examples include stainless steels or hardened polymers, for example, polyvinyl chloride (“PVC”) or a high-density polyethylene (“HDPE”) material.

Due to the heating process, the liquid removed from a vessel 14 is free of at least some of the harmful bacteria, viruses, microbes, and parasites originally present in the feedstock, yielding a purified liquid portion that may be suitable for immediate use or may require further purification in a downstream vessel 14 before it is suitable for its intended use. Consequently, the purified liquid portion may be delivered to the next vessel 14 in the series via their shared inter-vessel pipe for further purification, or routed via a pipe to bypass the next vessel 14 and instead deliver the purified liquid portion to a vessel 14 farther along the series for further purification, or routed for direct delivery to the outlet 20 of the series of vessels 14.

It should be appreciated that various levels of purification can be achieved by selecting the number of vessels 14 that a purified liquid must pass through before exiting the series of vessels 14 through the system exit 20. Moreover, certain vessels 14 may be operated at different parameters to promote the purification process with respect to one or more known or suspected contaminants in the feedstock. By operating all of the vessels 14 in series, a maximum level of purification can be attained for the purification system 10, for example, to produce potable water. However, in some cases fewer than all of the vessels 14 would be necessary to produce a treated liquid suitable for an intended purpose, for example, water intended for bathing. In the latter case, the purified liquid produced by the vessels 14 can be analyzed to determine which downstream vessels 14 are unnecessary to achieve the desired purification level.

In view of the above, it can be appreciated that a suitable control unit may use predetermined programs to maintain appropriate process parameters, including but not limited to temperature and pressure, depending on the characteristics of the feedstock and any purified liquid portion produced by any given vessel 14. Such characteristics may include the amounts and types of contaminants detected in the feedstock or purified liquid portion, and may be sensed using one or more appropriate analyzers. The control unit can be remotely controlled using a Wireless Internet Protocol, such as WAP, XHTML, and LAN, allowing a user to monitor and control the system 10 without being physical present at the site where the system 10 is located. If desired, a smart phone or other mobile electronic device can run an application that displays the control panel 32 and its various displayed information so that an operator can remotely identify a device operating outside its prescribed range or exhibiting an operating anomaly, and enable the operator to take corrective steps that may include remotely shutting down the system 10.

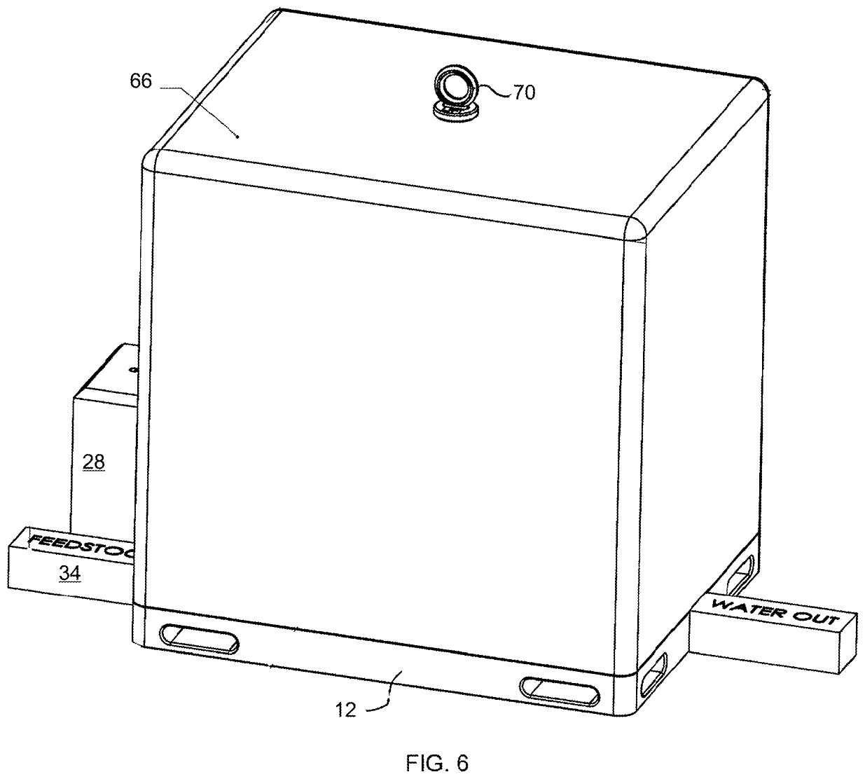

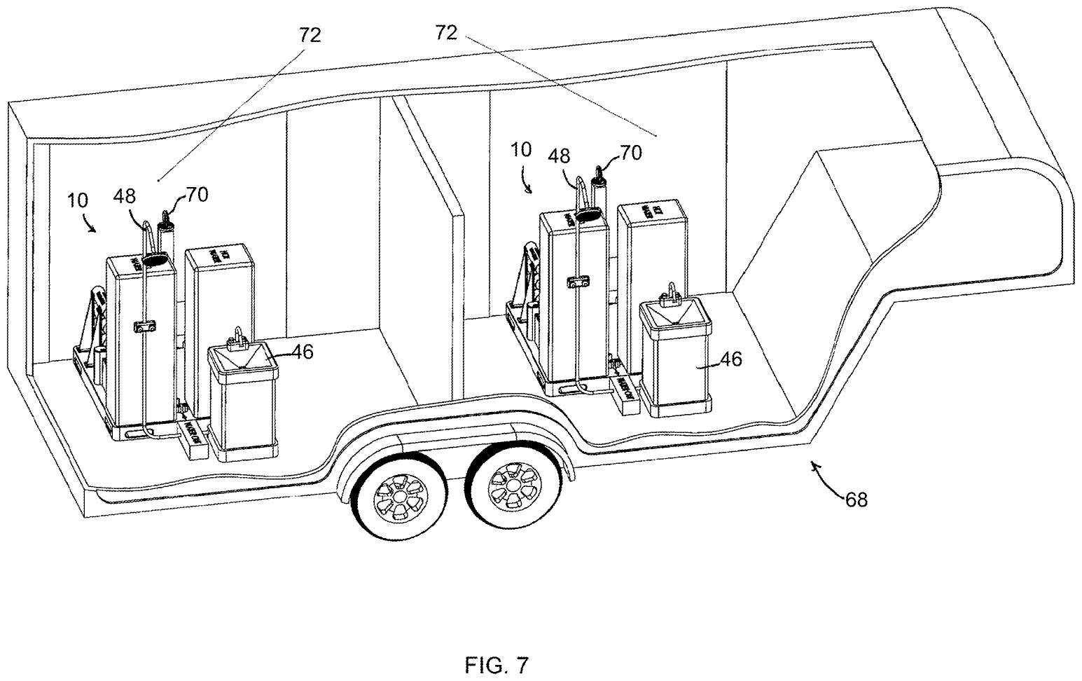

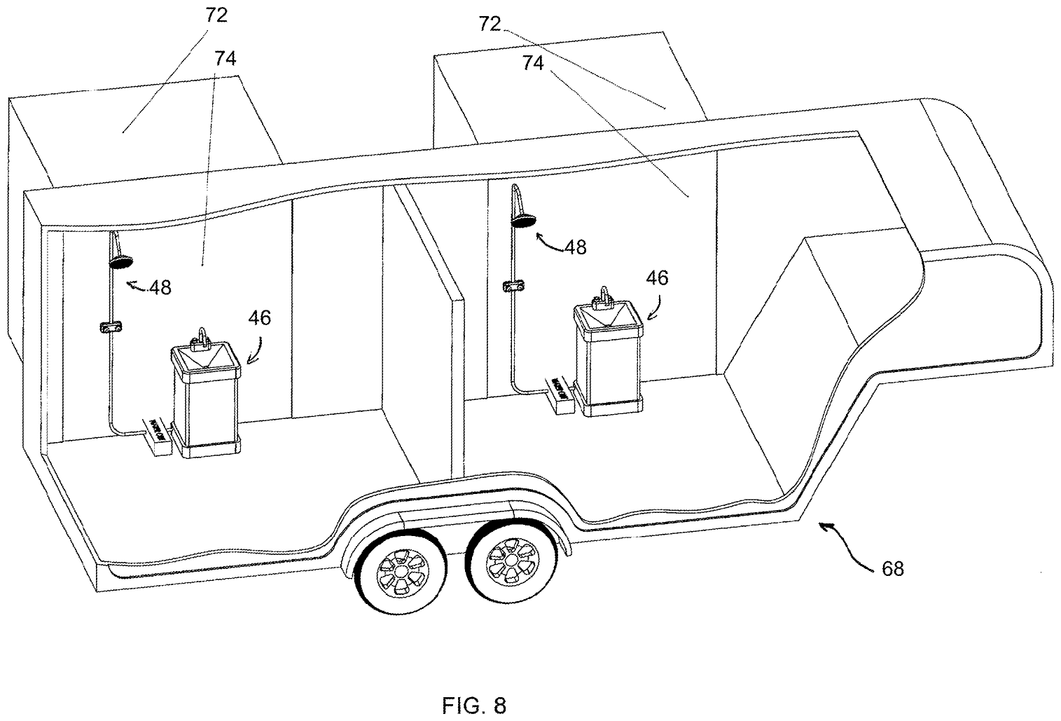

FIG. 6 schematically represents a single purification system 10 protectively housed in an enclosure 66, and FIGS. 7 and 8 represent two purification systems 10 mounted in a trailer 68. In each case, the systems 10 are equipped with a lift bar 70 that enables the systems 10 to be moved by a crane, helicopter, or any other suitable means. FIGS. 7 and 8 represent the trailer 68 as configured with sliding platforms 72 so that each system 10 can be positioned as a unit outside the interior of the trailer, and closure walls 74 that conceal the systems 10 so that users of the sink 46 or shower 48 are not subjected to sounds associated with the operation of the systems 10. The systems 10 offers versatilely while also providing considerable processing capacity, and can be transported to areas that would not normally be able to produce a purified liquid from an existing feedstock without having a permanent purification system and infrastructure in place, or alternatively, transporting the feedstock from another location. This aspect is particularly advantageous when the feedstock is a finite amount of contaminated water that does not require or warrant a permanent water purification plant.

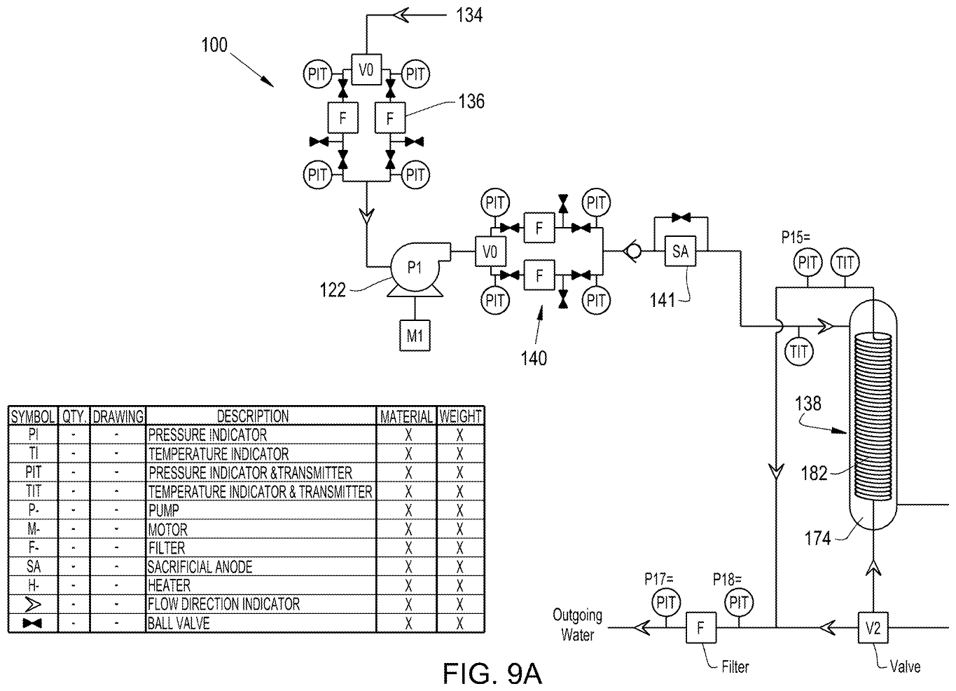

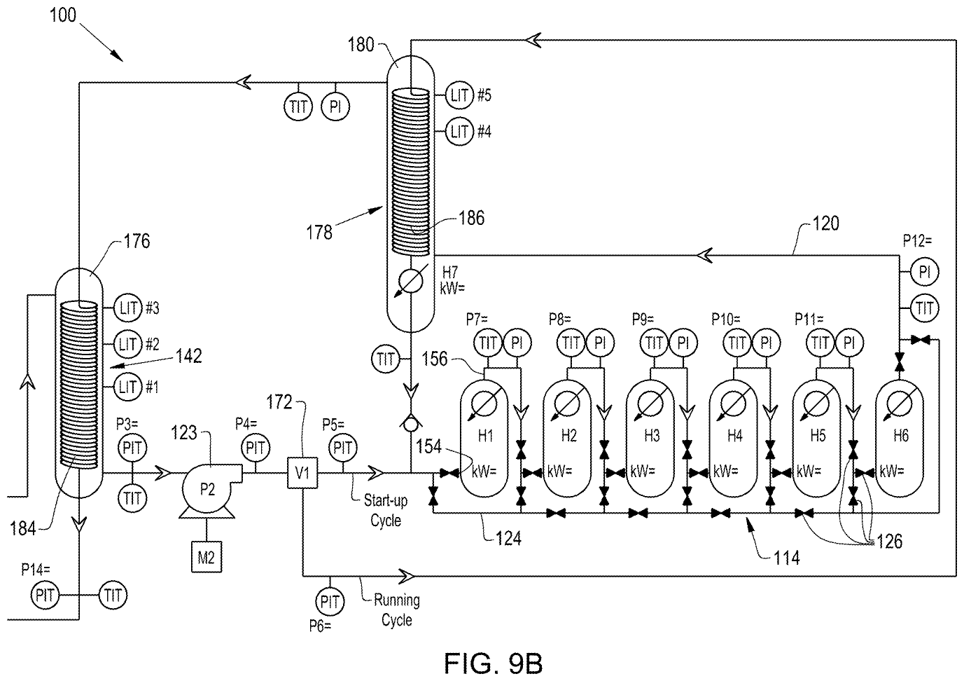

FIG. 9 represents a second embodiment of a purification system 100. In FIG. 9, consistent reference numbers are used to identify the same or functionally related/equivalent elements as described for the first embodiment of FIGS. 1 through 8, but with a numerical prefix “1” added to distinguish the system 100 from the embodiment of FIG. 1. In view of similarities between the first and second embodiments, the following discussion of FIG. 9 will focus primarily on aspects of the second embodiment that differ from the first embodiment in some notable or significant manner. Other aspects of the second embodiment not discussed in any detail can be, in terms of structure, function, materials, etc., essentially as was described for the first embodiment.

In FIG. 9, a pre-filter unit 136 and a filtration unit 140 are located upstream of all purification vessels 114 (labeled as H1-H6). The system 100 further includes a magnetic filter (sacrificial anode) 141 for removing any solids in the feedstock that can be magnetically extracted from the feedstock, notably including metals such as chromium (VI). The magnetic filter 141 preferably comprises a rare-earth magnet (e.g., NdFeB, SmCo, etc.) capable of also trapping biological matter that contains magnetic material, for example, mature malaria parasites. As such, the feedstock entering the remainder of the system 100 is preferably largely free of TDSs and potentially may contain less biological matter, and the contaminants remaining in the feedstock are primarily microscopic matter such as bacteria, viruses, microbes, and/or parasites. At least one additional filter is represented in FIG. 9 as being located downstream of the vessels 114 and immediately upstream of the exit (“outgoing water”) of the system 100. This downstream filter and the aforementioned upstream pre-filter unit 136 and filtration unit 140 are preferably low-pressure microbic, carbon catalytic filters.

The tanks 138 and 142 are represented as heat exchangers adapted to preheat the feedstock prior to the feedstock being delivered to the vessels 114 via a second pump 123. The system 100 is equipped with a valve 172 that enables the system 100 to operate in a “startup cycle” mode and a “running cycle” mode. In the startup cycle mode, the feedstock consecutively flows through interior chambers 174 and 176 of the tanks 138 and 142, respectively, after which the pump 123 and valve 172 route the feedstock directly to the series of vessels 114, with feedstock flow through the vessels 114 as indicated (feedstock enters near the lower end of each vessel 114, exits near the upper end of each vessel 114, similar to FIG. 5). From the vessels 114, the heated feedstock is delivered to a “hot tank” (preheater) 178 to fill an interior chamber 180 of the hot tank 178 with heated feedstock. Once the chamber 180 of the hot tank 178 is sufficiently filled (“LIT #4”) with heated feedstock, the valve 172 preferably routes the incoming feedstock from the pump 123 to a coil 186 within the hot tank 174 prior to the feedstock being routed to the vessels 114 and subsequently the chamber 180 of the hot tank 178. As such, the feedstock entering the vessels 114 is preheated by the feedstock flowing from the vessels 114. As a result of heat exchange between the feedstock entering and exiting the vessels 114, the feedstock exiting the chamber 180 of the hot tank 178 is cooled before continuing through a coil 184 in the tank 142 and, optionally, also through a coil 182 in the tank 138, which also serve to preheat the feedstock prior to being delivered to the vessels 114. Consequently, heat is harvested and reused within the system 100 to optimize BTU efficiencies and operating costs, and the water (“outgoing water”) exits the system 100 at a temperature much lower than otherwise. Whether flow occurs through the coil 182 of the tank 138 will depend on whether the water exiting the system 100 is at a desired cooler temperature, for example, for use as drinking water, bathing, etc.

FIG. 9 indicates various other aspects of the system 100, and additional components of the system 100 are identified whose functions within the system 100 should be readily appreciated as assisting in the operation and control of the system 100. For example, the vessels 114 are fluidically interconnected through inter-vessel pipes 124 equipped with valves 126. In combination, the inter-vessel pipes 124 and valves 126 enable flow from any vessel 114 in the series to be routed to any downstream or upstream vessel 114 in the series, and enable flow from any vessel 114 to be routed to the outlet 120.

The systems 10 and 100 described above offer the advantages of minimal loss of productivity or downtime, the avoidance of requiring additives, carrier gases, airborne contaminants, combustible compounds, etc., in the purification process, and the ability to remove a broad range of contaminants, including suspended solids, dissolved solids, immiscible liquids, heavy metals, chemicals, bacteria, viruses, microbes, and parasites that are commonly found in wastewater, fracking water, seawater, storm water, fertigation, and industrial waste.

While the invention has been described in terms of specific or particular embodiments, it should be apparent that alternatives could be adopted by one skilled in the art. For example, the systems 10 and 100 and their components could differ in appearance and construction from the embodiments described herein and shown in the drawings, functions of certain components of the systems 10 and 100 could be performed by components of different construction but capable of a similar (though not necessarily equivalent) function, process parameters such as temperatures and pressures could be modified, and appropriate materials could be substituted for those noted. As such, it should be understood that the above detailed description is intended to describe the particular embodiments represented in the drawings and certain but not necessarily all features and aspects thereof, and to identify certain but not necessarily all alternatives to the represented embodiments and described features and aspects. As a nonlimiting example, the invention encompasses additional or alternative embodiments in which one or more features or aspects of a particular embodiment could be eliminated or two or more features or aspects of different embodiments could be combined. Accordingly, it should be understood that the invention is not necessarily limited to any embodiment described herein or illustrated in the drawings, and the phraseology and terminology employed above are for the purpose of describing the illustrated embodiments and do not necessarily serve as limitations to the scope of the invention. Accordingly, it should be understood that the invention is not necessarily limited to any embodiment described herein or illustrated in the drawings. Therefore, the scope of the invention is to be limited only by the following claims.

1. A purification process for treating a feedstock containing a liquid and contaminants to remove the contaminants therefrom, the process comprising:
providing a system comprising a series of vessels that include a first vessel and a plurality of downstream vessels that are fluidically downstream from the first vessel, the series of vessels being fluidically connected to each other so that the first vessel can be selectively fluidically connected in fluidic series to any one or more of the downstream vessels;
removing at least some solid contaminants from the feedstock;
delivering the feedstock to the first vessel;
heating the feedstock in the first vessel while the feedstock is under a pressure greater than atmospheric pressure to yield a more purified first portion of the liquid;
delivering the first portion of the liquid to a first of the downstream vessels;
heating the first portion of the liquid in the first downstream vessel while the first portion is under a pressure greater than atmospheric pressure to yield a more purified second portion of the liquid;
removing the second portion of the liquid from the first downstream vessel; and
deriving a treated portion of the liquid from the second portion.

2. The purification process according to claim 1, further comprising collecting the treated portion of the liquid in a first tank and transferring some of the treated portion to a second tank where the liquid is cooled.

3. The purification process according to claim 1, further comprising delivering the second portion of the liquid to at least a second of the downstream vessels, heating the second portion of the liquid in the second downstream vessel while the second portion is under a pressure greater than atmospheric pressure to yield a more purified third portion of the liquid, and removing the third portion of the liquid from the second downstream vessel, whereby the treated portion is also derived from the third portion.

4. The purification process according to claim 3, further comprising collecting the treated portion of the liquid in a first tank and transferring some of the treated portion to a second tank where the liquid is cooled.

5. The purification process according to claim 1, wherein the pressures in the first vessel and the first downstream vessel are sufficiently high to inhibit boiling and control evaporation of the liquid.

6. The purification process according to claim 1, wherein the treated portion of the liquid is potable water.

7. The purification process according to claim 1 5, wherein the treated portion of the liquid is nonpotable water.

8. The purification process according to claim 1, further comprising altering the process to bypass the first downstream vessel and instead deliver the first portion of the liquid to a second downstream vessel.

9. The purification process according to claim 1, further comprising using a magnetic filter to remove solids in the feedstock that can be magnetically extracted from the feedstock.

10. The purification process according to claim 9, wherein the magnetic filter removes chromium (VI) from the feedstock.

11. The purification process according to claim 9, wherein the magnetic filter comprises a rare-earth magnet capable of trapping biological matter that contains a magnetic material.

12. The purification process according to claim 11, wherein the biological matter comprises mature malaria parasites.

13. The purification process according to claim 1, wherein the contaminants are chosen from the group consisting of elements of the periodic table, salt and other naturally-occurring and synthetic inorganic compounds, oils, fatty acids and other naturally-occurring and synthetic organic compounds, volatile compounds, radioactive particles, bacteria, viruses, microbes, and parasites.

14. The purification process according to claim 1, wherein the process is performed within a mobile system having wheels for transporting the mobile system to different geographic sites.

15. The purification process according to claim 1, wherein the feedstock is obtained from a source chosen from the group consisting of groundwater, flood water, surface water, wastewater, fracking water, seawater, brackish water, storm water, fertigation, and agriculture water.

16. A purification system for treating a feedstock containing a liquid and at least first and second contaminants to remove the first and second contaminants therefrom, the system comprising:
a series of vessels that include a first vessel and a plurality of downstream vessels that are fluidically downstream from the first vessel, the series of vessels being fluidically connected to each other so that the first vessel can be selectively fluidically connected in fluidic series to any one or more of the downstream vessels;
means for removing at least some solid contaminants from the feedstock;
means for delivering the feedstock to the first vessel;
means for heating the feedstock in the first vessel while the feedstock is under a pressure greater than atmospheric pressure to yield a more purified first portion of the liquid;
means for delivering the first portion of the liquid to a first of the downstream vessels;
means for heating the first portion of the liquid in the first downstream vessel while the first portion is under a pressure greater than atmospheric pressure to yield a more purified second portion of the liquid;
means for removing the second portion of the liquid from the first downstream vessel; and
means for deriving a treated portion of the liquid from the second portion.

17. The purification system according to claim 16, further comprising a first tank that collects the treated portion of the liquid and a second tank for cooling some of the treated portion drawn from the first tank.

18. The purification system according to claim 16, further comprising means for delivering the second portion of the liquid to at least a second of the downstream vessels, means for heating the second portion of the liquid in the second downstream vessel while the second portion is under a pressure greater than atmospheric pressure to yield a more purified third portion of the liquid, and means for removing the third portion of the liquid from the second downstream vessel, whereby the treated portion is also derived from the third portion.

19. The purification system according to claim 18, further comprising a first tank that collects the treated portion of the liquid and a second tank for cooling some of the treated portion drawn from the first tank.

20. The purification system according to claim 16, wherein the pressures in the first vessel and the first downstream vessel are sufficiently high to inhibit boiling and control evaporation of the liquid.

21. The purification system according to claim 16, wherein the treated portion of the liquid is potable water.

22. The purification system according to claim 1, wherein the treated portion of the liquid is nonpotable water.

23. The purification system according to claim 1, further comprising a magnetic filter that removes solids in the feedstock that can be magnetically extracted from the feedstock.

24. The purification system according to claim 23, wherein the magnetic filter removes chromium (VI) from the feedstock.

25. The purification system according to claim 23, wherein the magnetic filter comprises a rare-earth magnet capable of trapping biological matter that contains a magnetic material.

26. The purification system according to claim 25, wherein the biological matter comprises mature malaria parasites.

27. The purification system according to claim 16, wherein the contaminants are chosen from the group consisting of elements of the periodic table, salt and other naturally-occurring and synthetic inorganic compounds, oils, fatty acids and other naturally-occurring and synthetic organic compounds, volatile compounds, radioactive particles, bacteria, viruses, microbes, and parasites.

28. The purification system according to claim 16, wherein the system is part of a mobile system having wheels for transporting the system to different geographic sites.

29. The purification system according to claim 16, wherein the feedstock is obtained from a source chosen from the group consisting of groundwater, flood water, surface water, wastewater, fracking water, seawater, brackish water, storm water, fertigation, and agriculture water.
